(19) United States
(12) Patent Application Publication
(10) Pub. No.: US 2006/0105144 A1
(43) Pub. Date: May 18, 2006

(54) Decorative powder coated articles and methods thereof

(76) Inventor: Sergio Fracasso, Maglie (IT)

Correspondence Address: WEISS & MOY PC, 4204 NORTH BROWN AVENUE, SCOTTSDALE, AZ, 85251, US

(21) Appl. No.: 10/987,349

(22) Filed: Nov. 12, 2004

(51) Int. Cl. B05D 1/12; B05D 3/02; B05D 5/00; D06N 3/00

(52) U.S. Cl. 428/151; 427/180; 427/379; 427/256

(57) ABSTRACT

An article having an appearance of at least one of wood, marble and fabric is provided by selectively removing at least one layer of an uncured powder coating from a portion of a surface of the article pre-coated with a first layer of a partially cured powder coating and at least one second layer of an uncured powder coating. The uncured powder coating is removed with at least a plurality of pre-wetted thread-like fibers having a predetermined shape to simulate a desired decorative appearance. The uncured powder coating retained by the at least a plurality of pre-wetted thread-like fibers is separated into a liquid such as water and the uncured powder coating is separated from the liquid and recovered for further use. The first layer of the partially cured powder coating and the remainder of the at least one second layer of the uncured powder coating are substantially cured.

### FIELD OF THE INVENTION

This invention relates generally to coating methods and articles thereof and, more specifically, to improved decorated powder coated articles having desirable effects and designs (such as wood with knots and grain, marble with veins and fabrics) and powder coating methods thereof.

### BACKGROUND OF THE INVENTION

In the past a number of coating methods have provided articles with a decorative appearance on a surface of the articles. In particular such methods have provided articles having a surface which simulates the appearance of natural materials such as wood and marble. In certain parts of the world, city councils have appearance standards that require that modern materials fit in with their surroundings.

Known methods of decorating the surface of an article include: (1) photo-filming, in which a powder or liquid coating forming the background color is applied to a surface of the article to be decorated, followed by the application thereon of a film reproducing the desired decoration; (2) applying a PVC film having a desired decoration to a surface of the article by adhering to the surface of the article; (3) applying a first coating powder to a surface of an article and partially melting the first powder and maintaining the first powder at a temperature which is lower than the temperature at which a second powder completely melts followed by application of a second powder and melting of the first and second powder (see French Patent FR-A-2340140); (4) a painting process that uses two or more layers, wherein the first layer is a curable material (see UK Patent GB-A-1558464).

The present inventor has previously described yet another method for coating and decorating the surface of an article (see European Patent EP 0843598 B1) which comprises electro-statically applying a layer of a first colored powder material to the surface of the article to create a background layer on the surface of the article; heating the coated surface of the article in a first heating step to a temperature of about 90° C. for about 20 minutes; applying a second differently colored powder to the surface of the first colored powder on the surface of the article; and heating the both the first and the second colored powder on the surface of the article to a temperature of 180° C., thereby polymerizing the first and second colored powders. According to the invention disclosed in European Patent EP 0843598 B1, a portion of the surface of the article is mechanically wiped using a solvent to remove a portion of the powder prior to curing or patterned with a silk screen stencil to provide a desired decorative surface on the article.

The present inventor has recognized the need for improved methods of providing an article having a desired decorative surface, which overcome certain limitations in the previously disclosed European Patent EP 0843598 B1. In particular, in the present inventor's previously disclosed method (European Patent EP 0843598 B1), the inventor has recognized some environmental concerns, such as the need for solvents for cleanup and some manufacturing issues leading to increased costs of manufacturing due to loss of materials and shorter life of tools which provide the articles having desired decorative appearances. The current disclosure substantially overcomes such limitations, thereby resulting in coated articles having the desired appearance of natural materials manufactured by environmentally and cost effective processes.

### SUMMARY OF THE INVENTION

Accordingly, it is an object of this disclosure to provide an improved method for providing a decorative surface on a portion of an article.

It is a further object of this disclosure to provide an improved method for removing a non-cured powder coating from a portion of a surface of a powder coated article thereby providing a desirable decorative surface on the article.

It is a yet further object of this disclosure to provide an improved method for providing a decorative surface that simulates natural wood, marble and cloth on a portion of an article.

It is a still further object of this disclosure to provide an improved method for providing a decorative surface of an article which is environmentally friendly and cost effective.

It is a yet further object of this disclosure to provide an improved powder coated decorative article.

It is a further object of this disclosure to provide an improved article that has a surface which simulates natural wood, marble and cloth.

### PREFERRED EMBODIMENTS OF THE INVENTION

In accordance with one embodiment of this invention, a method for selectively decorating an article is disclosed. The method comprises the steps of coating a portion of a surface of the article with a first layer of a powder coating comprising at least one colorant and providing means for partially curing the first layer of the powder coating. The method further comprises the step of coating the partially cured first layer of the powder coating of the article with at least one second layer of a powder coating comprising at least one colorant, each one of the first layer of the partially cured powder coating and the at least one second layer of the powder coating having at least one different material property. The method further comprises the steps of providing means for selective powder coating removal and retention of a portion of the surface of the at least one second layer of the powder coating located on the first layer of the powder coating, coupling a portion of the selective powder coating removal and retention means selectively to a portion of the surface of the at least one second layer of the powder coating located on the first layer of the powder coating thereby providing the article with a desired decorative appearance and decoupling the selective powder coating removal and retention means completely from the surface of the at least one second layer of the powder coating of the article. The method further comprises the steps of providing means for immersing a portion of the selective powder coating removal and retention means in a liquid to separate the powder coating from the selective powder coating removal and retention means thereby permitting recovery of the powder coating, wetting the selective powder coating removal and retention means with the liquid; and substantially curing both the first layer of the powder coating and a remaining portion of the at least one second layer of the powder coating located on a portion of the surface of the article thereby providing the selectively decorated article. The liquid comprises water and further comprises at least one chemical component including at least one surfactant.

In accordance with a second embodiment of this invention, a decorated article is disclosed. The article is prepared by the above method and the decorated article has the appearance of at least one of wood, marble and fabric.

In accordance with a third embodiment of this invention, a method for selectively decorating an article is disclosed. The method comprises the steps of providing the article having a first layer of a partially cured powder coating comprising at least one colorant, providing the article having at least one second layer of an uncured powder coating comprising at least one colorant and located on a portion of the first layer of the article, each one of the first layer of the partially cured powder coating and the at least one second layer of the uncured powder coating having at least one different material property. The method further comprises the steps of providing at least a plurality of pre-wetted thread-like fibers having a predetermined decorative appearance, coupling at least a portion of the at least a plurality of pre-wetted thread-like fibers selectively to a portion of a surface of the at least one second layer of the uncured powder coating located on the first layer of the partially cured powder coating thereby contacting a portion of the at least one second layer of the uncured powder coating, decoupling the at least a plurality of pre-wetted thread-like fibers completely from the surface of the at least one second layer of the uncured powder coating of the article and transferring a portion of the at least one second layer of the uncured powder coating to a portion of a surface of the at least a plurality of pre-wetted thread-like fibers. The method further comprises the steps of immersing a portion of the at least a plurality of pre-wetted thread-like fibers in a liquid to separate the uncured powder coating thereby permitting recovery of the uncured powder coating, wetting a portion of a surface of the at least a plurality of pre-wetted thread-like fibers with the liquid and substantially curing both the first layer of the partially cured powder coating and a remaining portion of the at least one second layer of the uncured powder coating located on a portion of the surface of the article thereby providing the selectively decorated article.

The foregoing and other articles, features, and advantages of the invention will be apparent from the following more detailed description of the preferred embodiments of the invention, as illustrated in the accompanying drawings.

### BRIEF DESCRIPTION OF THE DRAWINGS

FIG. 1A is a perspective view showing a plurality of thread-like fibers and a plurality of swatches located on a portion of a surface of a belt, with the belt coupled to a portion of at least one pulley according to the present invention.

FIG. 1B is an exploded perspective view showing a more detailed view of a portion of the surface of the belt of FIG. 1A having the plurality of thread-like fibers and the plurality of swatches located thereon.

FIG. 2 is a perspective view showing a combination of the belt and the at least one pulley of FIG. 1A, with a portion of the combination of the belt and a portion of one of the at least one pulley immersed in a portion of a liquid located in a container.

FIG. 3 is a perspective view showing a plurality of belts with each one of the plurality of belts coupled to a portion of at least one pulley of a plurality of pulleys similar to the combination of the belt and at least one pulley configuration of FIG. 1A.

FIG. 4A is a perspective view showing a portion of a surface of an article being coated with a powder coating.

FIG. 4B is an end elevational view of the article of FIG. 4A including the powder coating on a portion of the surface of the article.

FIG. 5 is a perspective view of the combination of the belt and the at least one pulley of FIG. 1A further comprising a roller located on a back portion of the belt for coupling a portion of the surface of the belt having the plurality of thread-like fibers and the plurality of swatches to a portion of the powder coated surface of the article of FIG. 4A, thereby removing a portion of the powder coating from the surface of the article to provide a decorative appearance on the surface of the article.

FIG. 6 is a perspective view showing a portion of the decorative surface of the article of FIG. 4A after completing the process of removing a portion of the powder coating on the surface of the article as depicted in FIG. 5.

FIG. 7 is an end elevational view of a portion of the belt of FIG. 1 proximate to a portion of a powder coated outer surface of an article similar to FIG. 4B but having a substantially rectangular hollowed-out shape.

FIG. 8 is an end elevational view of a portion of two belts similar to the belt of FIG. 1A with each one of the belts located on opposite sides of an elevated portion of a powder coated surface of an article similar to FIG. 4B having a substantially rectangular hollowed-out shape, and a portion of each one of the belts proximate to the powder coated surface of the article.

FIG. 9 is an end elevational view of the combination of a portion of the belt of FIG. 1A coupled to the at least one pulley of FIG. 1A.

FIG. 10 is an end elevational view of a combination of a portion of two belts and each one of the belts coupled to at least one pulley of a plurality of pulleys similar to the configuration of the combination of the portion of the belt and the at least one pulley of FIG. 9.

FIG. 11 is a perspective view showing another embodiment of a plurality of thread-like fibers and at least one pulley, with a portion of the combination of the plurality of thread-like fibers and a portion of one of the at least one pulley immersed in a portion of a liquid located in a container.

### DESCRIPTION OF THE INVENTION

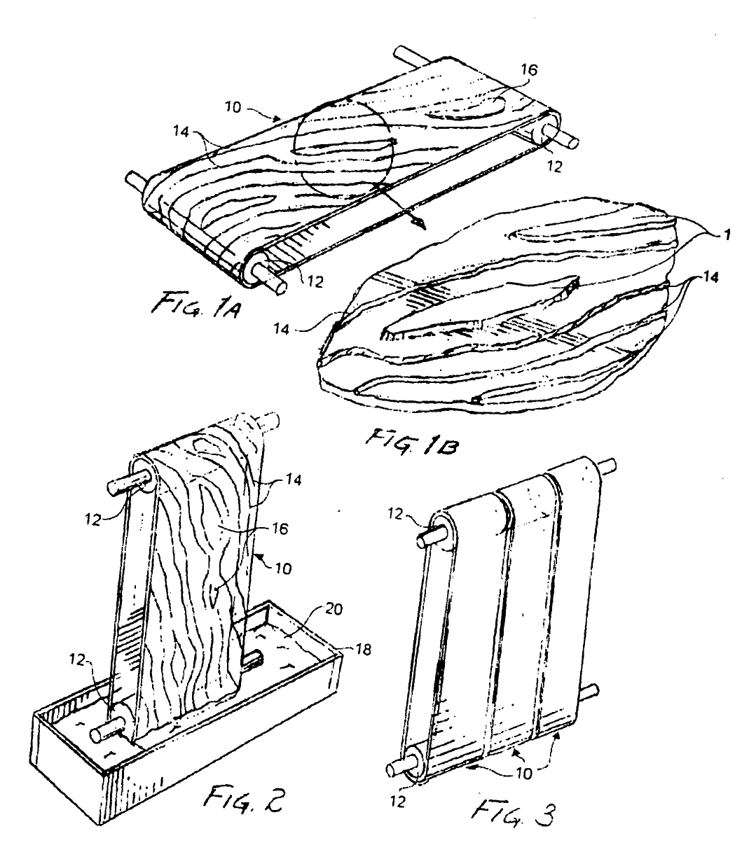

According to FIG. 1A, in one embodiment of a method for providing a decorative surface on a portion of a surface of an article 22 (see FIG. 6), at least one belt 10 of a portion of an apparatus (not shown) comprises a plurality of thread-like fibers 14 and a plurality of swatches 16 located on a portion of a surface of the belt 10, with the belt 10 coupled to a portion of at least one pulley 12. The plurality of swatches 16 comprises sculptured material including velvets and velcro-like materials and the like. The plurality of thread-like fibers 14 and the plurality of swatches 16 comprise natural and synthetic fibers alone or in combination and include cotton, silk, wool, cloth, paper, polymeric fibers such as nylon, polyester, copolymers thereof and the like. It is understood that the plurality of thread-like fibers 14 and the plurality of swatches 16 may be coupled by various means, such as stitching and adhesion, to a portion of the surface of the at least one belt 10.

The apparatus (not shown) comprises a mechanical portion and an electronic portion, with the mechanical portion comprising a chassis (not shown) having at least one pulley 12 coupled to the at least one belt 10. FIG. 1B is an exploded perspective view showing a more detailed view of a portion of the surface of the at least one belt 10 of FIG. 1A having the plurality of thread-like fibers 14 and the plurality of swatches 16 located thereon. It is understood that each of the plurality of thread-like fibers 14 and each of the plurality of swatches 16 have various dimensions according to the desired decorative appearance of the surface of the article 22. The plurality of thread-like fibers 14 and the plurality of swatches 16 provide desired effects or designs (such as a wooden appearance with knots and grain, a marble appearance, a fabric appearance, etc.) on a portion of a surface of the article 22. In one embodiment of the apparatus (not shown), each of the at least one pulley 12 are motor driven so that the at least one pulley 12 may be rotated thereby frictionally driving the at least one belt 10.

Referring to FIG. 2, a combination of the at least one belt 10 and the at least one pulley 12 of FIG. 1A is immersed in a portion of a liquid 20 located in a container 18, which cleans and pre-wets both the plurality of thread-like fibers 14 and the plurality of swatches 16 coupled to a portion of the surface of the at least one belt 10. It is understood that the container 18 may further comprise ultrasonic means or mechanical means such as rollers and brushes for enhanced cleaning of the plurality of thread-like fibers 14 and the plurality of swatches 16. The liquid 20 is preferably water and may further comprise at least one chemical component such as a surfactant, thereby further enhancing the wetting of the plurality of thread-like fibers 14 and the plurality of swatches 16. During the process of cleaning the rotation speed of the at least one pulley 12 and thereby the cleaning time and the degree of pre-wetting of the plurality of thread-like fibers 14 coupled to a portion of the surface of the at least one belt 10 is determined by a processor (not shown) comprising one of the electronic components of the apparatus (not shown).

Referring to FIG. 3, a plurality of belts 10 with each one of the plurality of belts 10 coupled to a portion of at least one pulley 12 of a plurality of pulleys 12 is similar to the combination of the at least one belt 10 and the at least one pulley 12 configuration of FIG. 1A. With reference to FIG. 3, it is understood that each one of the plurality of pulleys 12 may be located on a separate axis and further coupled to at least a member of the apparatus (not shown) permitting selective movement of the axis of each one of the plurality of pulleys 12, thereby providing asymmetrical and random pattern formation on a portion of the surface of the article 22.

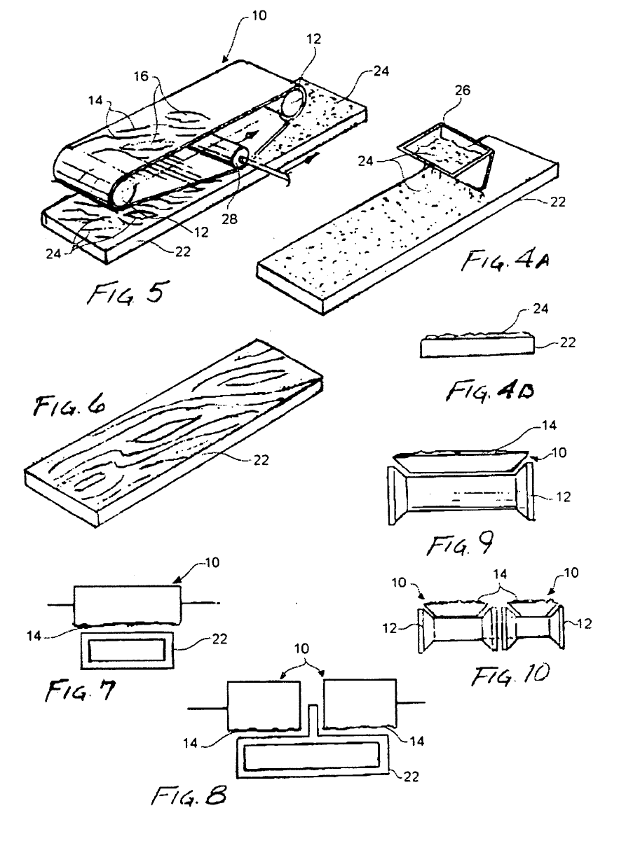

Referring now to FIG. 4A, a powder coating 24 is dispensed from a dispenser 26 onto a portion of the surface of the article 22. It is understood that various dispensing methods may be used and the depiction shown in FIG. 4A is merely illustrative of a powder coating dispensing process. One example of a preferred powder coating dispenser is an electrostatic spray gun propelling the powder coating 24 onto a portion of the surface of the article 22. The article 22 may include bars of metallic alloys, metallic sheets, various metallic alloy configurations, rings of metallic alloys, glass, materials comprising M.D.F. and other composites and the like. FIG. 4B is an end elevational view of the article 22 of FIG. 4A including the powder coating 24 on a portion of the surface of the article 22. It is understood that the article 22 may have various shapes.

Referring to FIG. 5, the combination of the at least one belt 10 and the at least one pulley 12 of FIG. 1A further comprises means for selectively coupling a portion of the surface of the at least one belt 10 having the plurality of thread-like fibers 14 and the plurality of swatches 16 to a portion of the surface of the article 22 having the powder coating 24 of FIG. 4A, thereby removing a portion of the powder coating 24 from a portion of the surface of the article 22 to provide a predetermined decorative appearance on the surface of the article 22. According to FIG. 5, in one embodiment, the means for selectively coupling a portion of the surface of the at least one belt 10 to a portion of the surface of the article 22 comprises a roller 28 located on a back portion of the at least one belt 10. The roller 28 may comprise a hard rubber-like material. It is understood that the means for selectively coupling a portion of the surface of the at least one belt 10 to a portion of the surface of the article 22 may comprise a bar of various shapes, a plurality of rollers, a plurality of roller bars, a comb-like article or a brush-like article and combinations thereof and the like. The plurality of thread-like fibers 14 and the plurality of swatches 16 coupled to the at least one belt 10 remove a portion of the uncured powder coating 24 from a portion of the surface of the article 22 and provide a desired effect such as the appearance of wood (see FIG. 5), marble, cloth and the like. In a preferred process step, during the contacting process for removing the powder coating as described above, the at least one belt 10 remains stationary while the roller 28 moves to provide contact of a portion of the surface of the belt 10 and a portion of the surface of the article 22 having the powder coating 24. However, it is understood that the article 22 may also be moved while in contact with the at least one belt 10 and also while not in contact with the at least one belt 10. In an alternative process the at least one belt 10, the roller 28 and the article 22 may move relative to one another. The processor of the apparatus (not shown) selects the nature of the rotational motion of the at least one pulley 12, the frequency of rotations, the distance of a portion of the surface of the article 22 from a portion of the surface of the at least one belt 10, the number of articles 22 to be processed, the pressure of the comb or brush-like portion on a portion of the surface of the at least one belt opposite to the surface of the belt comprising the thread-like fibers and all other factors that determine suitable functioning of the apparatus (not shown).

Referring to FIG. 6 the surface appearance of the article 22 has a wood grain appearance after the contacting process of FIG. 5 (described above) with a portion of the surface of the uncured powder coating 24 of the article 22 having been removed. Referring back to FIG. 2 where the plurality of thread-like fibers 14 and the plurality of swatches 16 of the at least one belt 10 are cleaned and pre-wetted in the liquid 20 of the container 18, it is now evident that the plurality of thread-like fibers 14 and the plurality of swatches 16 remove a portion of the powder coating 24 located on the surface of the article 22. The powder coating 24 on the plurality of thread-like fibers 14 and the plurality of swatches 16 may be removed by immersing the at least one belt 10 in the liquid 20 of the container 18 so that the loose powder coating may be recycled for re-use. The recovery of the powder coating 24 by filtration or centrifugation form the liquid 20 provides an economic benefit and is environmentally desirable.

Referring to FIG. 7 a portion of the at least one belt 10 of FIG. 1 is proximate to a portion of a powder coated outer surface of an article 22 similar to the article 22 of FIG. 4B but having a substantially rectangular hollowed-out shape. In FIG. 8, a portion of at least two belts 10 similar to the at least one belt 10 of FIG. 1A with each one of the at least two belts 10 located on opposite sides of an elevated portion of a powder coated surface of an article 22 similar to the article 22 of FIG. 4B having a substantially rectangular hollowed-out shape, and a portion of each one of the at least two belts 10 is proximate to the powder coated surface of the article 22. FIG. 8 depicts the versatility of the apparatus (not shown) with respect to types of articles 22 that may be processed efficiently.

FIG. 9 depicts an end elevational view of the combination of a portion of the at least one belt 10 of FIG. 1A coupled to the at least one pulley 12 of FIG. 1A, while FIG. 10 depicts an end elevational view of a combination of a portion of at least two belts 10 with each one of the at least two belts 10 coupled to at least one pulley 12 of a plurality of pulleys 12 similar to the configuration of the combination of the portion of the at least one belt 10 and the at least one pulley 12 of FIG. 9. Both FIGS. 9 and 10 show that a back portion of the at least one belt 10 is coupled to the at least one pulley 12 and that the plurality of thread-like fibers 14 (and also the plurality of swatches 16) are located on a portion of the surface of the at least one belt 10 opposite to the back portion of the at least one belt 10.

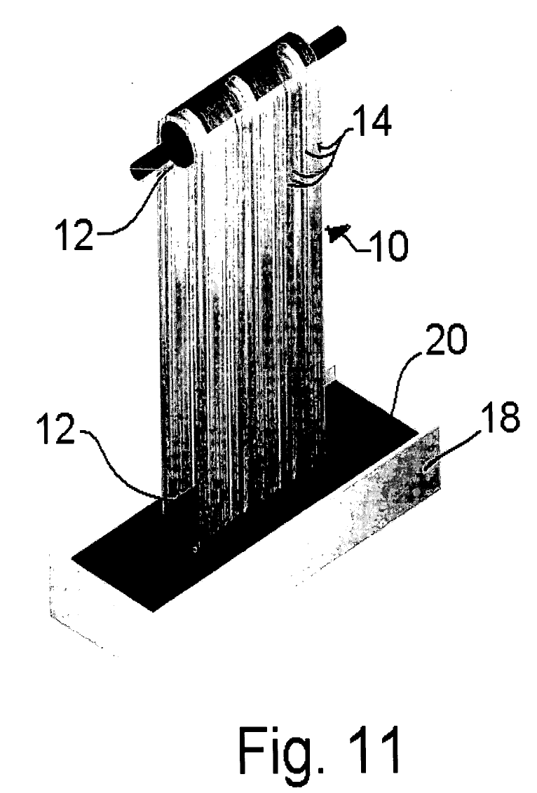

Referring to FIG. 11, another embodiment of a portion of an apparatus comprises a plurality of thread-like fibers 14 and at least one pulley 12, with a portion of the combination of the plurality of thread-like fibers 12 and a portion of one of the at least one pulley 12 immersed in a portion of a liquid 20 located in a container 18. Each one of the plurality of thread-like fibers 14 is selectively tensioned and thereby provides a predetermined random pattern on a portion of the surface of the article 22 having a powder coating 24 when a portion of the surface of the plurality of thread-like fibers 12 is moved by a roller 28 (i.e., means for coupling a portion of a back surface of the plurality of thread-like fibers 12 opposite to a portion of a front surface of the plurality of thread-like fibers 12).

The powder coating 24 comprising at least one colorant is a polymer selected from the group consisting of polyester, epoxy and epoxy polyester. Other suitable powder coatings 24 comprising at least one colorant are polymers and copolymers selected from the group consisting of polyester hydroxide alkylamide, polyurethane, acrylic, epoxy acrylic, acrylopolyurethane, acrylopolyester and epoxy phenolic and the like. Such polymers and copolymers are available from numerous sources including Akzo Nobel Coating, Rohm and Haas and Europolyeri. The at least one colorant may comprise a dye, a pigment, a mixture thereof and the like. A preferred embodiment of the powder coating 24 is a polymer with means for partially curing the powder coating 24 at a temperature of about 60° C. to 130° C. including heat activation, UV activation, other energy source activation, and a combination of these means for partially curing the powder coating 24.

Exemplary Method for Providing a Decorative Wood Appearance:

In one embodiment of a method for providing an article 22 having a wood decorative appearance, the method comprises the steps of coating a portion of the surface of the article 22 with a first layer of a powder coating 24 comprising at least one colorant, providing means for partially curing the first layer of the powder coating at a temperature of about 60° C. to 130° C. It is understood that means for partially curing include a heat source such as warm air, thermal panels for catalytically curing polymers, light bulbs, a UV source, or an e-beam source, and the like. Preferably the partially cured first layer of powder coating 24 provides a base layer on the article 22 defining a background color of a suitable wood.

The method further comprises the step of coating the first layer of powder coating 24 of the article 22 with at least one second layer of a powder coating 24, the first layer of powder coating 24 and the second layer of powder coating 24 having at least one different material property. It is understood that such at least one different material property comprises a physical property including color, tonality, texture and the like or a chemical property including chemical ingredients, cure characteristics and the like.

The method further comprises the step of providing means for selective removal and retention of a portion of the surface of the second layer of powder coating 24 located on the first layer of powder coating 24 on the surface of the article 22 thereby providing a desired decorative appearance. The means for selective removal and retention of a portion of the second layer of powder coating 24 from a portion of the surface of the article 22 comprises providing means for coupling at least one belt 10 to a portion of the surface of the at least one second layer of the powder coating 24. The at least one belt 10 comprises at least a plurality of pre-wetted thread-like fibers 14 located on a portion of a surface of the belt 10, with the at least one belt 10 coupled to a portion of at least one pulley 12. The at least one belt 10 may further comprise at least one pre-wetted swatch 16 to simulate at least one knot of a wood. The at least a plurality of pre-wetted thread-like fibers 14 simulate at least one grain of a wood. The means for coupling the at least one belt 10 to a portion of the surface of the at least one second layer of the powder coating 24 on the surface of the article 22 is located on a surface of the belt 10 opposite to the portion of a surface of the belt 10 comprising the at least a plurality of pre-wetted thread-like fibers 14 and is selected from the group consisting of at least one roller 28, at least one roller bar, at least one comb-like object and at least one brush-like object and combinations thereof and the like.

The method further comprises the steps of transferring a portion of the powder coating 24 removed from the at least one second layer of the powder coating 24 of the article 22 by a portion of the surface of the at least a plurality of pre-wetted thread-like fibers 14 and decoupling the at least one belt 10 from the surface of the at least one second layer of the powder coating 24 of the article 22, and providing means for immersing the at least one belt 10 in a portion of a liquid 20 located in a container 18 thereby cleaning and wetting the at least a plurality of pre-wetted thread-like fibers 14 coupled to a portion of the surface of the at least one belt 10. It is understood that the container 18 may further comprise ultrasonic means or mechanical means such as rollers and brushes for enhanced cleaning of the at least a plurality of pre-wetted thread-like fibers 14. The liquid 20 is preferably water and may further comprise at least one chemical component such as a surfactant, thereby further enhancing the wetting of the at least a plurality of pre-wetted thread-like fibers 14. The method further comprises the steps of moving the at least one belt 10 from the container 18 in preparation for coupling to a portion of another at least one second layer of a powder coating 24 located on a portion of the surface of another article 22, and separating the powder coating 24 retained in the liquid 20 thereby recovering the powder coating 24 removed from the at least one second layer of the powder coating 24.

The method further comprises the step of substantially curing the first layer of powder coating 24 and the remaining at least one second layer of powder coating 24 located on a portion of the surface of the article 22 thereby providing the article 22 having the desired wood appearance. It is understood that when a third layer of powder coating 24 is required on a portion of the surface of the article 22, the first layer of powder coating 24 and the at least one second layer of powder coating 24 of the article 22 may be partially cured rather than substantially cured, and a third uncured layer of powder coating 24 may be coated on the combination of the partially cured first layer of powder coating 24 and the partially cured at least one second layer of powder coating 24 of the article 22, and then the third uncured layer of powder coating 24 may be coupled to the at least one belt 10. It is further understood that the removal step mentioned above may be repeated for as many uncured layers of powder coating 24 as desired until a desired pattern or decoration has been applied to a portion of the surface of the article 22. Finally, it is understood that the multi-layered powder coated surface of the article 22 is substantially cured as described above.

Exemplary Method for Providing a Selectable Decorative Appearance:

The above described method for providing an article 22 having a wood decorated appearance may be altered to provide an article 22 having a selected decorative appearance. The method is the same as described above, with the following exceptions: providing a first layer of powder coating 24 comprising at least one colorant, providing at least a second layer of powder coating 24 comprising at least one colorant differing from the first layer of the powder coating 24, and providing at least one belt 10 comprising at least a plurality of pre-wetted thread-like fibers 14 so that the at least a plurality of pre-wetted thread-like fibers 14 simulate the appearance of the selected decorative appearance on a portion of the second layer of powder coating 24 of the article 22. The selected decorative appearance may comprise marble, fabric, combinations of wood, marble and fabric, and other desirable decorative appearances.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method for selectively decorating an article comprising the steps of:
coating a portion of a surface of said article with a first layer of a powder coating comprising at least one colorant;
providing means for partially curing said first layer of said powder coating;
coating said partially cured first layer of said powder coating of said article with at least one second layer of a powder coating comprising at least one colorant, each one of said first layer of said partially cured powder coating and said at least one second layer of said powder coating having at least one different material property;
providing means for selective removal and retention of a portion of the surface of said at least one second layer of said powder coating located on said first layer of said powder coating that has been partially cured;
coupling a portion of said selective removal and retention means selectively to a portion of the surface of said at least one second layer of said powder coating located on said first layer of said powder coating thereby providing said article with a desired decorative appearance;
transferring a portion of said at least one second layer of said powder coating located on said first layer of said powder coating to a portion of a surface of said removal and retention means;
decoupling said selective removal and retention means completely from the surface of said at least one second layer of said powder coating of said article;
providing means for immersing a portion of said selective removal and retention means in a liquid to separate said portion of said at least one second layer of said powder coating from said selective removal and retention means thereby permitting recovery of said portion of said at least one second layer of said powder coating;
wetting said selective removal and retention means with said liquid; and
substantially curing both said first layer of said powder coating and a remaining portion of said at least one second layer of said powder coating located on a portion of the surface of said article thereby providing said selectively decorated article.

2. The method according to claim 1 wherein each one of said first layer of said partially cured powder coating and said at least one second layer of said powder coating comprises a polymer selected from the group consisting of polyester, epoxy, epoxy polyester, polyester hydroxide alkylamide, polyurethane, acrylic, epoxy acrylic, acrylopolyurethane, acrylopolyester and epoxy phenolic.

3. The method according to claim 1 wherein said means for partially curing said first layer of said powder coating at a temperature of about 60° C. to 130° C. is selected from the group consisting of at least one of a heat source, a UV source and an e-beam source.

4. The method according to claim 1 wherein said liquid comprises water.

5. The method according to claim 4 wherein said liquid further comprising at least one chemical component including at least one surfactant.

6. The method according to claim 1 wherein said means for selective removal and retention of a portion of the surface of said at least one second layer of said powder coating comprises at least one belt comprising at least a plurality of pre-wetted thread-like fibers located on a portion of a surface of said belt.

7. The method according to claim 6 wherein said at least one belt further comprising at least one pre-wetted swatch located on a portion of a surface of said belt.

8. The method according to claim 6 wherein each one of said plurality of thread-like fibers having various dimensions is selected from the group consisting of at least one of a natural fiber and a synthetic fiber said natural fiber including at least one of cotton, silk, wool, cloth and paper, and said synthetic fiber including at least one of nylon, polyester and copolymers thereof.

9. The method according to claim 6 wherein said means for selective removal and retention of a portion of the surface of said at least one second layer of said powder coating further comprising selective coupling means located on a portion of a surface of said belt opposite said at least a plurality of pre-wetted thread-like fibers, said selective coupling means selected from the group consisting of at least one of a roller, a bar having various shapes, a comb-like object and a brush-like object.

10. The method according to claim 1 wherein said means for selective removal and retention of a portion of the surface of said at least one second layer of said powder coating comprises at least a plurality of pre-wetted thread-like fibers coupled to a portion of at least one pulley.

11. The method according to claim 1 further comprising the step of: providing a container, said liquid located in said container; and providing said means for immersing a portion of said selective removal and retention means in said liquid comprising a portion of at least one belt having at least a plurality of pre-wetted thread-like fibers coupled to at least one pulley, said at least one pulley driving and immersing at least a portion of said at least one belt in said liquid.

12. The method according to claim 11 wherein said container further comprising at least one of ultrasonic means or mechanical means for enhanced cleaning of the at least a plurality of pre-wetted thread-like fibers.

13. The method according to claim 11 further comprising the steps of:
separating said powder coating from said selective removal and retention means into said liquid; wetting each one of said at least a plurality of pre-wetted thread-like fibers with said liquid; and
separating said powder coating from said liquid thereby recovering said powder coating removed from said at least one second layer of said powder coating of said article.

14. The method according to claim 1 wherein said article is selected from the group consisting of at least one of a metal, a glass and a composite.

15. A decorated article prepared by the method according to claim 1, said decorated article having the appearance of at least one of wood, marble and fabric.

16. A method for selectively decorating an article comprising the steps of:
providing said article having a first layer of a partially cured powder coating comprising at least one colorant;
providing said article having at least one second layer of an uncured powder coating comprising at least one colorant and located on a portion of said first layer of said article, each one of said first layer of said partially cured powder coating and said at least one second layer of said uncured powder coating having at least one different material property;
providing at least a plurality of pre-wetted thread-like fibers having a predetermined decorative appearance;
coupling at least a portion of said at least a plurality of pre-wetted thread-like fibers selectively to a portion of a surface of said at least one second layer of said uncured powder coating located on said first layer of said partially cured powder coating thereby contacting a portion of said at least one second layer of said uncured powder coating;
transferring a portion of said at least one second layer of said uncured powder coating located on said first layer of said partially cured powder coating to a portion of a surface of said at least a plurality of pre-wetted thread-like fibers;
decoupling said at least a plurality of pre-wetted thread-like fibers completely from the surface of said at least one second layer of said uncured powder coating of said article;
immersing a portion of said at least a plurality of pre-wetted thread-like fibers in a liquid to separate said uncured powder coating thereby permitting recovery of said uncured powder coating;
wetting a portion of a surface of said at least a plurality of pre-wetted thread-like fibers with said liquid; and
substantially curing both said first layer of said partially cured powder coating and a remaining portion of said at least one second layer of said uncured powder coating located on a portion of the surface of said article thereby providing said selectively decorated article.

17. The method according to claim 16 wherein each one of said first layer of said partially cured powder coating and said at least one second layer of said uncured powder coating comprises a polymer selected from the group consisting of polyester, epoxy, epoxy polyester, polyester hydroxide alkylamide, polyurethane, acrylic, epoxy acrylic, acrylopolyurethane, acrylopolyester and epoxy phenolic.

18. The method according to claim 16 wherein said liquid comprises at least water.

19. The method according to claim 16 further comprising the steps of:
separating said uncured powder coating from said at least a plurality of pre-wetted thread-like fibers into said liquid;
wetting each one of said at least a plurality of pre-wetted thread-like fibers with said liquid; and
separating said uncured powder coating from said liquid thereby recovering said uncured powder coating removed from said at least one second layer of said uncured powder coating of said article.
